(19) United States
(12) Patent Application Publication
(10) Pub. No.: US 2022/0021944 A1
(43) Pub. Date: Jan. 20, 2022

(54) RICH MEDIA ENVIRONMENT

(71) Applicant: Playrcart Limited, London (GB)

(72) Inventors: Glen DORMIEUX, London (GB); Richard MASON, London (GB)

(21) Appl. No.: 17/377,075

(22) Filed: Jul. 15, 2021

Related U.S. Application Data
(60) Provisional application No. 63/053,061, filed on Jul. 17, 2020.
(60) Provisional application No. 63/162,394, filed on Mar. 17, 2021.

(51) Int. Cl. H04N 21/478; H04N 21/431; H04N 21/234; H04N 21/858; H04N 21/8543; H04N 21/81; H04N 21/443

(52) U.S. Cl. CPC H04N 21/47815; H04N 21/4312; H04N 21/23424; H04N 21/4431; H04N 21/8543; H04N 21/812; H04N 21/8586

(57) ABSTRACT

The present invention provides a Rich Media Environment configurable to provide the user with a seamless way of conducting transactions from within a window of the rich media environment itself. All intermediate steps relating to the required transaction are carried out by calling up relevant modules/applications from within the application libraries from within an e-commerce platform. In preferred embodiments, the rich media environment is configured to be served a rich media file from a file location such as a server or other content delivery network (CDN). The rich media environment is further configured be initialized based on the content of the rich media file and configured to display predefined overlays to the user based on the content of the rich media file. The content owner can upload the rich media files to a server or other CDN via a dashboard/user interface. The parameters can be added to the rich media file using a plurality of fields to enable the desired functionality to be achieved.

### CROSS-REFERENCES TO RELATED APPLICATIONS

This application claims priority to U.S. Provisional Application No. 63/053,061, filed on Jul. 17, 2021, entitled “MEDIA PLAYER” and U.S. Provisional Application No. 63/162,394, filed on Mar. 17, 2021, entitled “RICH MEDIA ENVIRONMENT”. The contents of which are hereby incorporated by reference in their entirety for all purposes.

### BACKGROUND OF THE INVENTION

The increase in the use of and reliance on multimedia platforms has led to an increased focus on utilizing these platforms to advertise and sell products and services to the end user. Conventionally, the user would identify a product or service of interest within the player window and would then be required to locate the product or service via separate searches using a browser or through the use of embedded hyperlinks which redirect the user to the appropriate page of a website where the user can then complete the required transaction. In both cases, the user is necessarily directed away from the media player window and the associated content displayed there.

### SUMMARY OF THE INVENTION

According to a first aspect of the present invention, there is provided a method for displaying a rich media file within a rich media environment, comprising the steps of: serving the rich media file from a file location; initializing the rich media environment based on one or more parameters stored within the rich media file to define the layout of the rich media environment; displaying content associated with the rich media file within the rich media environment; displaying an interaction overlay element within the rich media environment; detecting a user input associated with the interaction overlay element; and, initiating the display of a transaction overlay element for detecting further user inputs within the rich media environment.

In one or more embodiments the rich media environment can be one of: a rich media ad unit, a rich media player, and, a rich media envelope.

In one or more embodiments, the rich media file can be a rich media ad file.

In one or more embodiments, the rich media file can be served on one of: an ad server, a dedicated content delivery network (CDN), and, a dedicated database.

In one or more embodiments, the interaction overlay element can be defined by one or more parameters stored in the rich media file.

In one or more embodiments, the interaction overlay element is associated with the displayed content of the rich media file.

In one or more embodiments, the transaction overlay element is an e-commerce transaction interface.

In one or more embodiments, the transaction overlay element relates to a transaction consisting of one or more of: a data submission form, purchasing an item, making a booking, making a donation, and registering for a service.

In one or more embodiments, the rich media file is one of a music video, a film, an advertisement, and a video clip.

In one or more embodiments, the rich media file includes information relating to the location of and type of interaction icon to be displayed to the user.

In one or more embodiments, initializing the rich media environment includes one or more of displaying an interaction overlay element title, a transaction type and a product/service identifier.

In one or more embodiments, the rich media file includes metadata tags which identify one or more of an external integration module, a commerce API, a content API, a payment provider, and a content delivery network.

In one or more embodiments the metadata is added to the rich media file using one of: a HTML5 language; javascript; and other suitable technical architecture.

In one or more embodiments the rich media environment is configured to communicate with one or more external transaction services. Preferably, the one or more external transaction services includes a payment provider.

In one or more embodiments the one or more external transaction services includes an order fulfilment service provider.

In one or more embodiments, displaying content associated with the rich media file comprises loading the content from the rich media file or retrieving the content from a content delivery network.

According to a second aspect of the present invention there is provided a computer program product comprising instructions for performing the method of the first aspect of the invention.

According to a third aspect of the present invention, there is provided a system configured for displaying a rich media file within a rich media environment, the system comprising: a rich media file served to a rich media environment from a file location; the rich media file configured to: initialize the rich media environment based on one or more parameters stored within the rich media file to define the layout of the rich media environment; display content associated with the rich media file within the rich media environment; and display an interaction overlay element within the rich media environment to facilitate transactions within the rich media environment; and, a rich media environment comprising computer executable instructions for performing the method of the first aspect of the present invention.

In one or more embodiments the system further comprises one or more service integration modules selected from a commerce API, a content API, a payment provider, and a content delivery network.

In one or more embodiments of the system the interaction overlay element is associated with the displayed content of the rich media file.

In one or more embodiments the interaction overlay element is configured to communicate with one or more external transaction services in response to user input to display a transaction overlay element within the rich media environment.

In one or more embodiments of the system the transaction overlay element is an e-commerce transaction interface.

In one or more embodiments of the system the transaction overlay element relates to a transaction consisting of one or more of: a data submission form, purchasing an item, making a booking, making a donation, and registering for a service.

In one or more embodiments of the system the rich media file includes information relating to one or more of an interaction overlay element title, a transaction type, a product/service identifier, a start time for displaying interaction overlay, and an end time to stop displaying the interaction overlay element.

In one or more embodiments of the system the rich media file includes metadata tags which identify one or more of a commerce API, a content API, a payment provider, and a content delivery network.

In one or more embodiments of the system the rich media environment is configured to communicate with one or more external transaction services. Further, the system may be used with the methods described herein.

### BRIEF DESCRIPTION OF THE DRAWINGS

An example of the present invention will now be described in detail with reference to the accompanying drawings, in which:

FIG. 1 shows an example of a sequence of window views (a) to (g) displayed within a rich media environment during initialization and loading of a rich media file;

FIG. 2 shows a representation of a rich media file and its associated content;

FIG. 3 shows a flow diagram outlining a process of uploading and storing the rich media file for subsequent retrieval;

FIG. 4 shows an example of a rich media environment configured to interact with external e-commerce applications via a video commerce platform architecture;

FIG. 5 shows a flow diagram outlining a process for loading a rich media file including locating external modules and e-commerce applications;

FIG. 6 shows an overview of the rich media environment and platform architecture, showing coding layers within a rich media file; and,

FIG. 7 illustrates dataflow between the rich media environment and the e-commerce platform.

### DETAILED DESCRIPTION

The present invention provides a rich media environment configured to provide the user with a seamless way of conducting transactions from within a window/display of the rich media environment itself. All intermediate steps relating to the required transaction are carried out within the rich media environment by calling up relevant modules/applications from application libraries from within an e-commerce platform without redirecting the user to alternate webpages and without the need for loading additional displays, windows or tabs. The window or display of the rich media environment can be considered as being the page on which the media content is being displayed to the user. Alternatively, the window or display of the rich media environment may consist of a dedicated tab within a window. The rich media content may be displayed via dedicated software that is run within the given window or tab. The transaction that is conducted upon detection of user interaction with the displayed rich media content can be completed within the same window or tab in which the rich media content is being displayed without the need to load any additional windows or tabs. This allows for the user to complete the transaction in a seamless way utilising only minimal additional computer resources. In summary, when completing the transaction, the user will not be redirected to a different window or tab and the transaction can be completed using an overlay element that is presented over the rich media content in the same display window or tab.

The rich media environment may be one of a rich media ad unit, a rich media application or a rich media player. For simplicity, the rich media environment will be referred to as a rich media ad unit throughout this disclosure. However, it should be noted that rich media environment, rich media player or rich media application can be equally applicable.

In preferred embodiments, the rich media ad unit is configured to retrieve a rich media file from a server or other content delivery network (CDN) which serves the rich media file to the rich media ad unit. The rich media file may be one of a generic media file or a rich media ad file.

The rich media ad unit is further configured to display predefined overlays to the user once the rich media ad unit has initialized.

The rich media file may include metadata tags which define a plurality of parameters for initializing the rich media ad unit and determining the type and form of the content to present within the rich media ad unit. The content can include parameters which define an actionable icon that is to be presented to the user within the rich media ad unit as well as its location and appearance. The appearance of the actionable icon may be based on content that is to be retrieved from the rich media file itself or direct the rich media ad unit to retrieve the content form a content delivery network (CDN) using the parameters which may be defined using the metadata tags/parameters.

The metadata tags relating to the type of action for each actionable icon also directs the rich media ad unit to the relevant interaction overlay element to display and towards any necessary application libraries and external applications required to complete the relevant functions. The metadata tags also define details relating to any products/services being offered to the user.

In preferred embodiments, the rich media ad unit is configured to display to the user an actionable icon via a predefined overlay rendered within the rich media ad unit alongside any content native to the website/page on which the rich media ad is being deployed/served once the rich media file is loaded.

The interaction overlay element is configured to be displayed while the content from the rich media file is being presented. Furthermore, the interaction overlay element is an element that a user can interact with (e.g. an element of a user interface) to initiate a predefined action.

The rich media ad unit is further configured to display to the user the progress of the transaction via another predefined overlay which directs the platform to call the relevant modules/applications required to provide the desired functionality. Once the transaction has been completed within the rich media ad unit, the overlay element can be hidden from view or the actionable icon may be configured to no longer initiate the first predefined action, or alternatively the type of action may be changed based on a predefined list of actions within the rich media file. This allows for a seamless and intuitive experience to the end user.

In preferred embodiments, the rich media ad unit is configured to display an actionable icon at a predefined location within the rich media ad unit according to the parameters stored within the rich media file which are defined by the content owner (or their proxy) via a dashboard/portal interface when uploading the rich media file to the server for storage and subsequent retrieval. The actionable icon is presented by using a predefined interaction overlay element which can display an icon with the required action, for example “Buy”, “Book” or “Donate”. It will be appreciated that the transaction may alternatively include registering for subscription services or filling out questionnaires, entering competitions or any other action which requires further input from the user. The relevant modules/applications required to fulfil those actions are identified when the parameters are added to the rich media file.

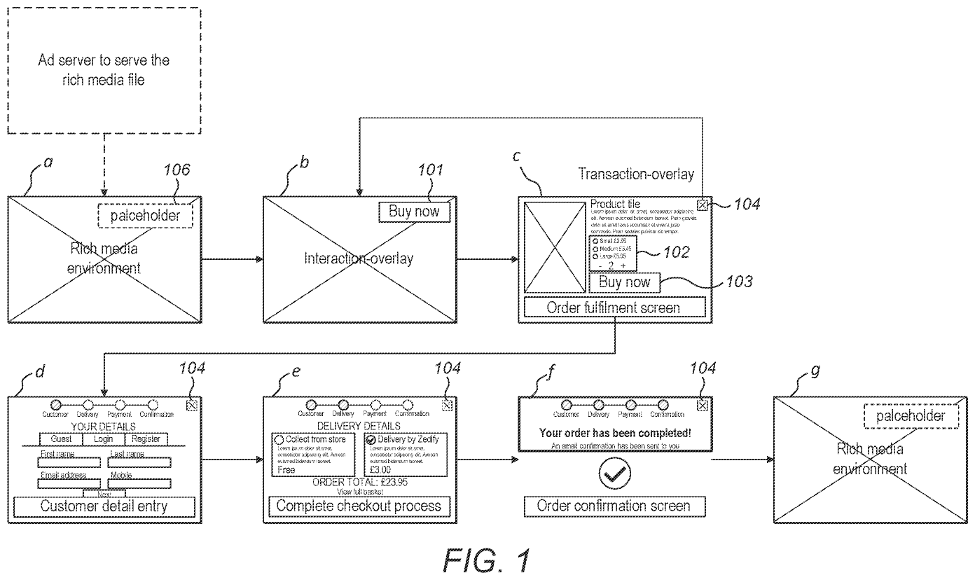

FIG. 1 shows an example of a sequence of views (a) to (g) of the window of a rich media ad unit/rich media environment which are displayed during the initialization of the rich media ad unit and the subsequent interaction with an interactive overlay as defined by the rich media file. The example of FIG. 1 is specifically directed towards making purchases once the rich media ad unit has been initialized based on the rich media file and the window views outlined in FIG. 1 display the various stages of completing the transaction. For alternative functions different intermediate stages would be displayed.

The display of the rich media ad unit is reconfigured during the initialization stage as defined by the parameters within the rich media file. The rich media ad unit can be incorporated into any existing media player or web page on any platform with a dedicated plug in, or alternatively can be a rich media ad unit which replaces an existing page on a website. Alternatively, the rich media ad unit may be configured to be incorporated into any one of a plurality of content streaming devices such as smart TVs.

Upon serving a rich media file to the rich media ad unit, the rich media ad unit is configured to initialize and identify sections of the rich media ad unit as placeholders (106) for displaying subsequent content as defined within the rich media file as in window (a). The required rich media file to be loaded can be defined by one or more of the hosting website, the advertiser, or the Playrcart platform and stored on a dedicated ad server [i.e. the dashed box in FIG. 1].

During initialization, the rich media ad unit is configured to display a predefined interaction overlay element according to the placeholders 106 identified in window (a). Window (b) shows an example actionable icon being presented to the user. The actionable icon 101 can be one of “Buy Now” or “Book” or “Donate” button or an icon to identify any other predefined action. This actionable icon is displayed as soon as the rich media ad unit has been initialized.

Parameters relating to the actionable icon are defined within the rich media file including defining the type of action: i.e. buy now, book, data capture or donate.

Additional parameters that can be identified within the rich media file include but are not limited to:

identifying the checkout flow,

define available currencies,

define available languages,

general terms and conditions content,

stock control in place,

list of product details

stock/tickets availability,

fields for data capture,

donation settings (min max amounts etc).

Other parameters can also be defined depending on the type of action that is to be completed.

Parameters defined within the rich media file can be selected by the content owner during the uploading of the rich media file to the ad server/CDN/database which then allow the rich media file to be served to the rich media environment.

The interaction overlay element can be configured to cover the entire rich media ad unit or only a part of it, the interaction overlay element can be semi-transparent or have sections which are transparent in order to avoid completely obscuring the content being displayed on the remainder of the rich media ad unit window. Each particular overlay can be tailored by the content owner or alternatively, one of a pre-set number of overlays associated with each particular action can be selected for ease of use. Parameters of the overlay that can be tailored include one or more of the colour schemes, the font, the specific icon parameters as well as incorporating the content owner branding within the overlay if desired.

If the user interacts with the actionable icon 101, the rich media ad unit is configured to replace the interaction overlay element with a subsequent transaction overlay element to allow the user to input details to complete the subsequent action within the rich media ad unit. User interaction includes one of clicking, hovering over, or other defined actions, these can be identified in the rich media file when defining the parameters of interaction overlay element.

The transaction overlay element in windows (c) to (f) display a checkout process for completing a transaction. The transaction overlay element also allows the user to cancel the transaction by selecting a cancel icon 104 anytime during the checkout procedure which returns the user back to the view of the interaction overlay element as defined in the rich media file.

As shown in the figures, the rich media ad unit displays the transaction overlay element within the rich media ad unit window, thereby avoiding the need for additional resources such as memory or processing power, as well as providing a much more intuitive experience for the user.

The transaction overlay element is configured to enable the user to enter the required data for completing one of a plurality of predefined actions such as for example completing a purchase, making a donation, making a booking, or any other action requiring the completion of a data submission form (window (d)). The transaction overlay element presented for the alternative actions will be specific to the action selected.

The rich media ad unit is configured to process the desired transaction using any one of a plurality of existing fulfilment services and to render the progress of the transaction to the user within the transaction overlay element so as to avoid the need to navigate through additional windows which again saves on resources and provides a much more intuitive experience.

Once the desired action is completed, this is communicated to the user via updating the transaction overlay element and the rich media ad unit is configured to remove the overlays and return to the initiation stage according to the rich media file (window (g)).

Alternatively, if the rich media file includes a dedicated advert file the rich media file may be configured such that upon completion of the transaction the rich media ad unit can be served another rich media file from the ad server and display a different actionable icon to the user and the rich media ad unit can be re-configured according to the parameters of the subsequent rich media file.

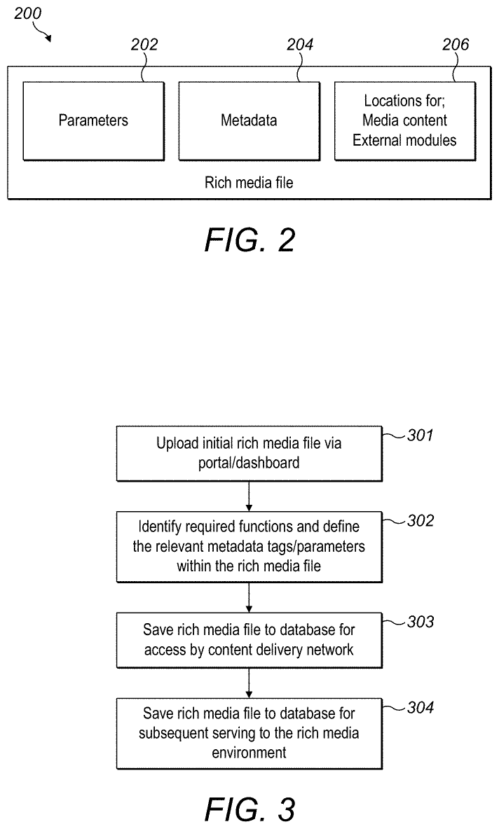

FIG. 2 shows a representation of a rich media file 200 and identifies some of the content that is stored within the rich media file itself. The rich media file can have information relating to the parameters 202, the metadata 204, as well as information relating to the external modules/media content 206 to be presented to the user.

FIG. 3 shows an example flow diagram outlining a process of uploading and storing the rich media file to be later served to the rich media ad unit. The process is achieved by using a user accessible portal/dashboard to upload the rich media file 301 to a server. The required functions for the rich media ad unit are identified and added as metadata tags/parameters within the rich media file 302. The metadata tags/parameters are configured to direct the rich media ad unit to use the relevant content and application libraries during initialization to achieve the required functionality. The rich media file is stored in a database/ad server for access by the CDN. The rich media file is stored for later retrieval and serving to the rich media ad unit 304.

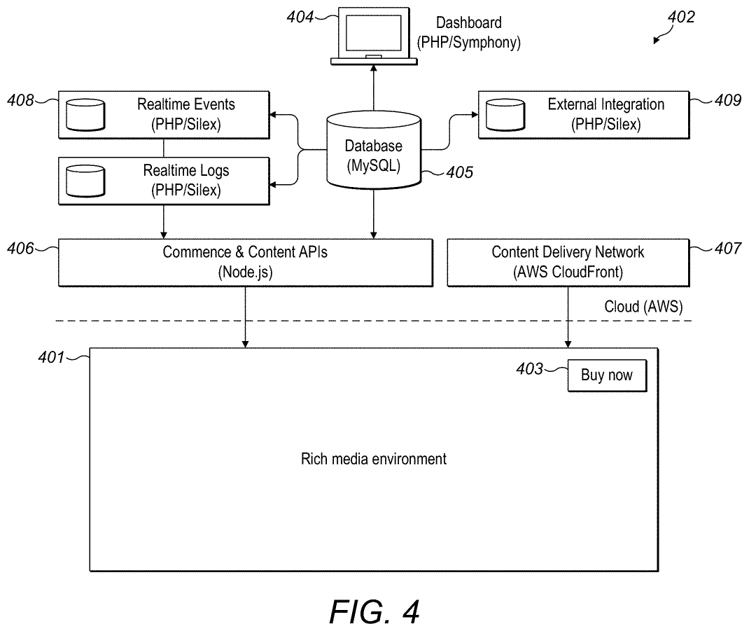

FIG. 4 shows an example of a rich media ad unit window 401 and how it is configured to interact with external applications via an e-commerce platform architecture 402. The platform architecture 402 facilitates the arrangement of the various modules and external applications to enable the required actions upon interacting with the actionable icon 403 in the rich media ad unit window 401. FIG. 4 also shows a user dashboard 404 which can be used to upload and edit the initial rich media file before storing rich media file in a database 405. The required rich media file is served to the rich media ad unit from the database via the CDN 407. The metadata tags/parameters added to the rich media files are linked to the external modules 408, 409 via the e-commerce and content APIs 406. This can be achieved using hyperlinks or other alternatives which cause the required application to be launched upon the actionable icon being selected in the media player window.

The rich media files are currently defined using an industry standard protocol such as HTML5. The HTML5 is used to define the parameters and metadata tags within each of the rich media files. However, any other suitable programming languages can be equally used.

Furthermore, other technical architectures can also be implemented and used to define the rich media files.

The embodiment shown in FIG. 4 allows content owners to have secure access to the database that stores their content so they can upload and edit the rich media files as required. For instance, different products may be added to an existing rich media file or a product/service may no longer be available and needs to be removed. The database can be stored on any number of secure servers such as local servers or cloud storage providers/ad servers.

The database 405 is updated by way of a dashboard/user interface or other user accessible portal. Access to the secure servers allows new content to be uploaded or existing content to be edited by the content owner alone, different content owners may have access to different databases or secure parts of the same database. The dashboard can also provide the content owner a suite of editing functions to enable the content owner to easily modify their rich media file before uploading. The content owner may also edit the rich media files offline using compatible protocols/languages. Rich media files which are created without using the dashboard are assessed for compatibility with the technical architecture that is being implemented to ensure the rich media file is compatible before storing the rich media file in the server via the dashboard/user interface.

The content owner can use the dashboard to define the parameters of the actionable icon and any subsequent actions following detection of user interaction and also after completion of a range of predefined actions. Once the rich media file has been edited, it is saved and stored in the database with a range of associated metadata tags/parameters to identify the rich media file. The rich media file is then stored ready to be served to the rich media ad unit as required.

FIG. 4 also illustrates the use of APIs 406. These are pre-existing applications which can provide the required functionalities in the background without the user having to navigate to those individual pages. In the example of a purchase, the user would not be required to navigate to the merchant web site to place the order and would not subsequently be required to navigate to a separate web page to complete payment etc. This is especially convenient when product placement type advertisements are used, where navigating away from the content would not be desirable. The use of APIs also provides for a more robust and reliable system which can ensure high availability, high scalability, reliable commerce functionality including payment processing/fulfilment, with additional benefits including the ability to provide real-time statistics and data logging capabilities as well as ensuring reliable integration with third party systems.

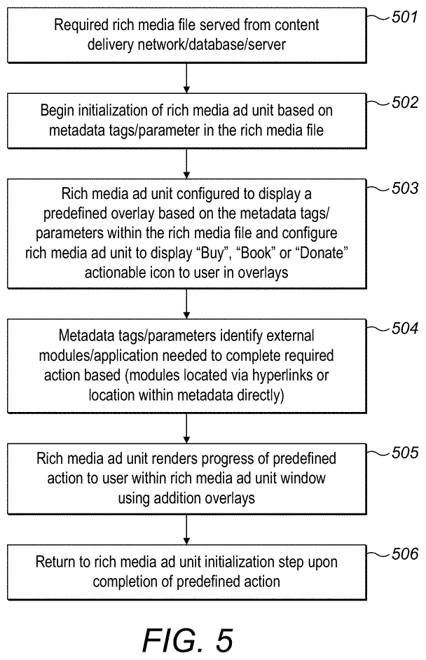

FIG. 5 shows a flow diagram illustrating a process for initialization of the rich media ad unit, including locating external modules and applications for providing required functions upon interaction with the displayed interaction overlay. The process for initialization requires the desired rich media file to be served from the database via the CDN 501. For example, the rich media file may be loaded/retrieved from a file location. The rich media ad unit window begins initialization based on the metadata tags/parameters in the rich media file 502, it will be appreciated that the rich media file can be one of a music video, a film, an advertisement, a video clip or any other rich media file. Furthermore, a rich media file in the context of this application can be taken to mean:
“a file for an ad that includes advanced features like video, audio, or other elements that encourage viewers to interact and/or engage with the content. While text ads sell with words, and display ads sell with pictures, rich media ads offer more ways for the audience to interact and/or engage with an ad”.

Once initialized, the rich media ad unit is configured to display a predefined overlay based on the metadata tags/parameters in the rich media file within the rich media ad unit window 503, it will be appreciated that the initialization step can be completed very quickly and so the predefined overlay can be presented as soon as the rich media ad unit is served. Loading of the required overlay also identifies the necessary external modules to complete the relevant transactions based on the metadata tags/parameters 504 defined within the rich media file. The progress of the selected function is rendered to the user via subsequent overlays which allow the user to complete the necessary transaction 505. Upon completion of the transaction, the rich media ad unit returns to the initialization step based on a further parameter within the rich media file or a subsequent rich media file that is served.

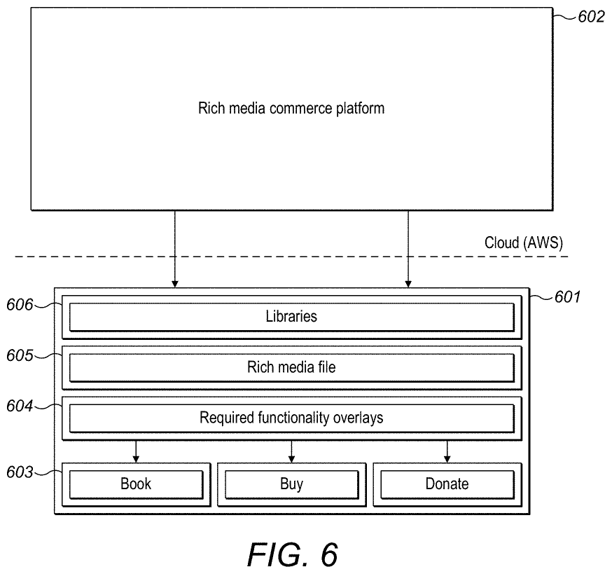

FIG. 6 shows an example embodiment of the coding layers within the rich media ad unit which enable the required functionality to be achieved. The rich media ad unit 601 is linked to the e-commerce platform 602. The rich media ad unit has predefined overlays 604 stored which allow the required functions to be realised 603.

The rich media file causes the relevant overlay to be presented to the user upon detecting the metadata tags/parameters associated with those actions during initialization of the rich media ad unit in accordance with the content of the rich media file 605. The metadata tags/parameters also direct the rich media ad unit to load up the required applications and associated content libraries 606 required to deliver the necessary functionality to the user. In one example, the e-commerce and API client libraries as well as the e-commerce functionality are provided by external third-party providers and are integrated into the commerce platform. The example transactions shown in FIG. 6 include, but are not limited to:

1) Making a booking or reservation

2) Purchasing of a product

3) Making a donation.

The user can use the dashboard to apply metadata tags/parameters within specified fields for each rich media file. The rich media file content can be used to initialize the rich media ad unit as shown below:

|$(document).ready(function( ) {
| init( );
});
var playrcart_api_domain = ‘https://api.playrcart.com’;
var playrcart_api_token = ‘ ’;
// Initialise the ad.
function init( ) {
| console.log(‘Run init( ).’);
| // Display the loading page.
| $(′#error′).fadeOut(500, function( ){
| | $(′#error-messages′).html(′ ′);
| | $(′#loading′).fadeIn(500, function( ) {
| | | checkRegistered( ).done(function(response){
| | | | if (response.DeviceStatusID = = 1) {
| | | | | // Get all data.
| | | | | | getAllData( ).done(function(response){
| | | | | | | $(′#loading′).fadeOut(500, function( ){
| | | | | | | | // Start video
| | | | | | | | initVideoPlayer( );
| | | | | | | | // Configure checkout
| | | | | | | | initCheckout( );
| | | | | | | });
| | | | | | } else {
| | | | | | | $(′#loading′).fadeOut(500, function( )
| | | | | | | { $(′#error′).fadeIn(500); });
| | | | | });
| | | | }
| | | });
| | });
| });
}

The above section of code allows the rich media ad unit to be initialized and defines how the rich media ad unit is to be displayed to the user as well as when to display the predefined content to the user within the rich media ad unit.

An example of the coding used to define the rich media ad unit content is shown below.

//Get all data the ad needs from apis.
var deferred2 = new $.Deferred( );
function getAllData( ) {
| console.log(′Run getAllDate( ).′);
| try {
| | // Get settings
| | response = getSettingsData( ).then(function( ) {
| | | if (settings_data !=null) {
| | | | // Check type of data needed
| | | | if (settings_data.device.device_status_id == 1) {
| | | | | // Get all data for video and buy/book/
| | | | | capture/dontae configuration.
| | | | | response = $.when(getVideo( ), getBuyData( ),
| | | | | getBookData( ),
| | | | | getCaptureData( ), getDonateData( )).
| | | | | done(function( ){
| | | | | | deferred2.resolve( );
| | | | | }).fail(function( ){
| | | | | | deferred2.reject( );
| | | | | });
| | | | } else {
| | | | | console.log(′This device is not active.′);
| | | | | $(′#error-messages).append
| | | | | (′This device is not active.<br />′);
| | | | | $(′#error′).fadeIn(400);
| | | | | deferred2.reject( );
| | | | }
| | | } else {
| | | | console.log(‘Settings data was not loaded.’);
| | | | $(′#error-messages′).append
| | | | (′Settings data was not loaded.<br />′);
| | | | $(′#error′).fadeIn(400);
| | | | deferred2.reject( );
| | | }
| | | return response;
| | });
| } catch(err) {
| | console.log(‘′getAllData( ):′+err.message);
| }
| return deferred2.promise( );
}

The above gives an example of the function that pulls the data from the various APIs to achieve the desired functionality. This function is referred to as the “getALLdata” function and is called during the initialization step (line 18 in the first example code).

Furthermore, each of the rich media files have associated metadata tags/parameters to identify the type of products/services on offer and how these are to be presented using subsequent overlays within the rich media ad unit. One example of this is shown below:

[
| {
| | “player_id”: 1889,
| | “player_name”: “Liz Earle”,
| | “player_type” {
| | | “player_type_id”: 1,
| | | “player_type_name”: “buy”,
| | },
| | “client_id”: 19,
| | “videos”: [
| | | {
| | | | “scr”:“https:∨∨playrcart.s3-eu-west-1.
| | | | 1.amazonaws.com∨vid5f16ab48021e2.mp4”,
| | | | “type”:“video∨mp4”,
| | | | “quality” :“medium”
| | | },
| | ]
| | “action_label”: “BUY NOW”,
| | “font”: “Aria!”,
| | “loading_color”: “#ffffff ”,
| | “background_color”: “#009900”,
| | “title_color”: “#000000”,
| | “input_color”: “#eeeeee”,
| | “button_color”: “#000000”
| | “button_text_color”: “#ffffff”,
| | “include_powered_by”: true,
| | “product_option_ids”: “322,323”,
| | “uuid”: “player-97623286-7b36-47d2-bd21-
| | 7a4972b6cb8c”
| }
]

The above shows the parameters of the interaction overlay element, including the type of function as well as the location content to be presented to the user.

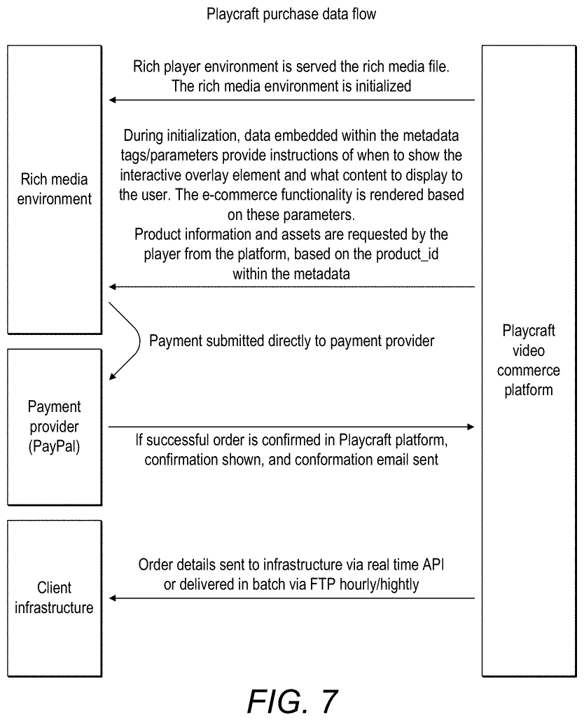

FIG. 7 shows an example embodiment of the dataflow between the rich media ad unit and the e-commerce platform. The rich media ad unit is configured to load the required content from the CDN hosted by the e-commerce platform based on the parameters in the rich media file. Once the required rich media file loaded, the rich media ad unit can be initialized.

While the rich media ad unit is being initialized, the metadata tags/parameters added by the content owner provide the rich media ad unit with instructions as to where and when the rich media ad unit should be reconfigured to display the dedicated actionable icons which enable the user to interact with and to initiate a predefined action.

The transaction overlay element is also configured to render the progress of the subsequent stages of the commerce action including any payment fulfilment requirements, the progress is rendered via the rich media ad unit window with all data processing being completed in the background via dedicated APIs and communicated via integration modules. The user is only presented with a summary of the progress and can complete the required action before returning to the rich media ad unit window upon completion of the transaction.

Any order placement and confirmation emails are subsequently communicated to the user via the existing mechanisms in place with the third party applications being used in the background.

In some example embodiments the set of instructions/method steps described above are implemented as functional and software instructions embodied as a set of executable instructions which are effected on a computer or machine which is programmed with and controlled by said executable instructions. Such instructions are loaded for execution on a processor (such as one or more CPUs). The term processor includes microprocessors, microcontrollers, processor modules or subsystems (including one or more microprocessors or microcontrollers), or other control or computing devices. A processor can refer to a single component or to plural components.

In other examples, the set of instructions/methods illustrated herein, and data and instructions associated therewith are stored in respective storage devices, which are implemented as one or more non-transient machine or computer-readable or computer-usable storage media or mediums. Such computer-readable or computer usable storage medium or media is (are) considered to be part of an article (or article of manufacture). An article or article of manufacture can refer to any manufactured single component or multiple components. The non-transient machine or computer usable media or mediums as defined herein excludes signals, but such media or mediums may be capable of receiving and processing information from signals and/or other transient mediums.

Example embodiments of the material discussed in this specification can be implemented in whole or in part through network, computer, or data based devices and/or services. These may include cloud, internet, intranet, mobile, desktop, processor, look-up table, microcontroller, consumer equipment, infrastructure, or other enabling devices and services. As may be used herein and in the claims, the following non-exclusive definitions are provided.

What is claimed is:

1. A method for displaying a rich media file within a rich media environment, comprising the steps of:
serving the rich media file from a file location;
initializing the rich media environment based on one or more parameters stored within the rich media file to define the layout of the rich media environment;
displaying content associated with the rich media file within the rich media environment;
displaying an interaction overlay element within the rich media environment;
detecting a user input associated with the interaction overlay element; and,
initiating the display of a transaction overlay element for detecting further user inputs within the rich media environment.

2. A method for displaying a rich media file according to claim 1, wherein the rich media environment is one of a:
rich media ad unit;
rich media player; and,
rich media envelope.

3. A method for displaying a rich media file of claim 1, wherein the rich media file is a rich media ad file.

4. A method for displaying a rich media of claim 1, wherein the rich media file is served on one of:
an ad server;
a dedicated content delivery network (CDN); and,
a dedicated database.

5. A method for displaying a rich media file of claim 1, wherein the interaction overlay element is defined by the one or more parameters stored in the rich media file.

6. A method for displaying a rich media file according to claim 1, wherein the interaction overlay element is associated with the presented content of the rich media file.

7. A method for displaying a rich media file according to claim 1, wherein the transaction overlay element is an e-commerce transaction interface.

8. A method for displaying a rich media file according to claim 1, wherein the transaction overlay element relates to a transaction consisting of one or more of:
a data submission form, purchasing an item, making a booking, making a donation, and registering for a service.

9. A method for displaying a rich media file according to claim 1, wherein the rich media file comprises one or more of a music video, a film, an advertisement, and a video clip.

10. A method for displaying a rich media file according to claim 1, wherein the rich media file includes information relating to the location of and type of interaction icon to be displayed to the user.

11. A method for displaying a rich media file according to claim 1, wherein initializing the rich media environment includes one or more of displaying an interaction overlay element title, a transaction type and a product/service identifier.

12. A method for displaying a rich media file according to claim 1, wherein the rich media file includes metadata tags which identify one or more of an external integration module, a commerce API, a content API, a payment provider, and a content delivery network.

13. A method for displaying a rich media file according to claim 12, wherein the metadata is added to the rich media file using one of:
a HTML5 language;
javascript; and,
other suitable technical architecture.

14. A method for displaying a rich media file according to claim 1, wherein the rich media environment is configured to communicate with one or more external transaction services.

15. A method for displaying a rich media file according to claim 14, wherein the one or more external transaction services includes a payment provider.

16. A method according to claim 1, wherein displaying content associated with the rich media file comprises loading the content from the rich media file or retrieving the content from a content delivery network.

17. A computer program product comprising instructions for performing the method of claim 1.

18. A system for displaying a rich media file within a rich media environment, the system comprising:
a rich media file served to a rich media environment from a file location;
the rich media file configured to:
initialize the rich media environment based on one or more parameters stored within the rich media file to define the layout of the rich media environment;
display content associated with the rich media file within the rich media environment; and,
display an interaction overlay element within the rich media environment to facilitate transactions within the rich media environment; and, a rich media environment comprising computer executable instructions for performing the method of any of claim 1.

19. A system according to claim 18, further comprising one or more service integration modules selected from a commerce API, a content API, a payment provider, and a content delivery network.

20. A system according to claim 18, wherein the interaction overlay element is associated with the displayed content of the rich media file.
